(19) United States
(12) Patent Application Publication
(10) Pub. No.: US 2019/0266463 A1
(43) Pub. Date: Aug. 29, 2019

(54) RFID protection and low frequency signal isolation sheet for folding wallet

(71) Applicant: Ya-Yi Wang, Taichung (TW)

(72) Inventor: Ya-Yi Wang, Taichung (TW)

(21) Appl. No.: 16/409,821

(22) Filed: May 12, 2019

(51) Int. Cl. G06K 19/073; A45C 1/06

(52) U.S. Cl. CPC G06K 19/07327; A45C 2011/186; A45C 1/06

(57) ABSTRACT

An RFID protection and low frequency signal isolation sheet for a folding wallet has a metal interlayer. Upper surface and the lower surface of the metal interlayer are covered with protective layers to form an RFID protection folding sheet. The RFID protection folding sheet is inserted into a cash compartment of a folding wallet. The RFID protection folding sheet has a length slightly less than that of the cash compartment. The RFID protection folding sheet has a width slightly less than a depth of the cash compartment. The RFID protection folding sheet is placed into the cash compartment and located at an inner edge close to an outer layer of the folding wallet. By folding the folding wallet, the RFID protection folding sheet forms the peripheral protection of the folding wallet, and the data of the electronic chips (RFID) of cards inside the folding wallet is blocked.

### FIELD OF THE INVENTION

The present invention relates to an RFID protection and low frequency signal isolation sheet for a folding wallet. An RFID protection folding sheet is placed into a cash compartment of the folding wallet. By folding the folding wallet, the RFID protection folding sheet forms the peripheral protection of the folding wallet, and the data of the electronic chips (RFID) of a plurality of cards inside the folding wallet is blocked, thereby effectively blocking the transmission and reception of electronic signals or electromagnetic waves inside and outside the folding wallet to achieve the effect of RFID protection.

### BACKGROUND OF THE INVENTION

Radio Frequency Identification (RFID) systems are widely used in everyday life, such as mobile phones, passports, bank cards and credit cards. When the user uses a credit card for payment, the RFID chip of the credit card needs to be sensed by a signal sensor, and the information of the user can be known through the data identification of the signal sensor to determine whether it is a legitimate user identity. When the determination is correct, the credit card can be used for payment. This is convenient and time-saving, without change.

With the expansion of the RFID applications, most people usually have at least one RFID proximity card. For carrying conveniently, multiple RFID proximity cards are often placed in the wallet and taken out when needed. Most users place the wallet in the pocket of the trousers or in an easy-to-access place. When an illegitimate person uses a smart scanner or a mobile phone with a NFC module to read the cards, the data of the RFID proximity card in the wallet will be recorded. The personal information inside the RFID proximity card is stolen, resulting in the user's identity or the RFID proximity card being copied by the illegitimate person, and causing personal data or financial loss.

Accordingly, the inventor of the present invention has devoted himself based on his many years of practical experiences to solve these problems.

### SUMMARY OF THE INVENTION

The primary object of the present invention is to provide an RFID protection and low frequency signal isolation sheet for a folding wallet, having a metal interlayer. Upper surface and the lower surface of the metal interlayer are covered with protective layers to form an RFID protection folding sheet. The RFID protection folding sheet is inserted into a cash compartment of a folding wallet. The RFID protection folding sheet has a length slightly less than that of the cash compartment. The RFID protection folding sheet has a width slightly less than a depth of the cash compartment. The RFID protection folding sheet is placed into the cash compartment and located at an inner edge close to an outer layer of the folding wallet. By folding the folding wallet, the RFID protection folding sheet forms the peripheral protection of the folding wallet, and the data of the electronic chips (RFID) of a plurality of cards inside the folding wallet is blocked, thereby effectively blocking the transmission and reception of electronic signals or electromagnetic waves inside and outside the folding wallet to achieve the effect of RFID protection.

Preferably, the protective layers are made of a wear-resistant and flexible material to protect the RFID protection folding sheet for durability. The present invention has high economic benefits.

Preferably, the metal interlayer has a thickness of at least 0.3 mm to block the transmission and reception of electronic signals or electromagnetic waves inside and outside the folding wallet and to facilitate folding of the metal interlayer by folding the folding wallet.

### BRIEF DESCRIPTION OF THE DRAWINGS

FIG. 1 is a perspective view of the present invention;

FIG. 2 is a top cross-sectional view taken along line 2-2 of FIG. 1;

FIG. 2A is an enlarged view of circle A of FIG. 2;

FIG. 3 is a perspective view showing the operation of the present invention when in use;

FIG. 4 is a perspective view of the present invention when in use; and

FIG. 5 is a schematic view of the present invention used to block the transmission and reception of electronic signals or electromagnetic waves inside and outside the folding wallet.

### DETAILED DESCRIPTION OF THE PREFERRED EMBODIMENTS

Embodiments of the present invention will now be described, by way of example only, with reference to the accompanying drawings.

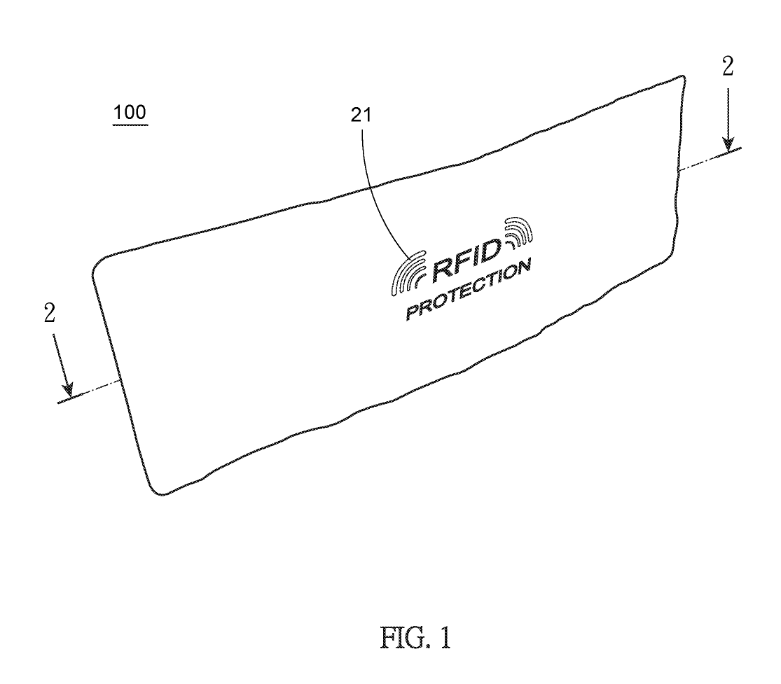

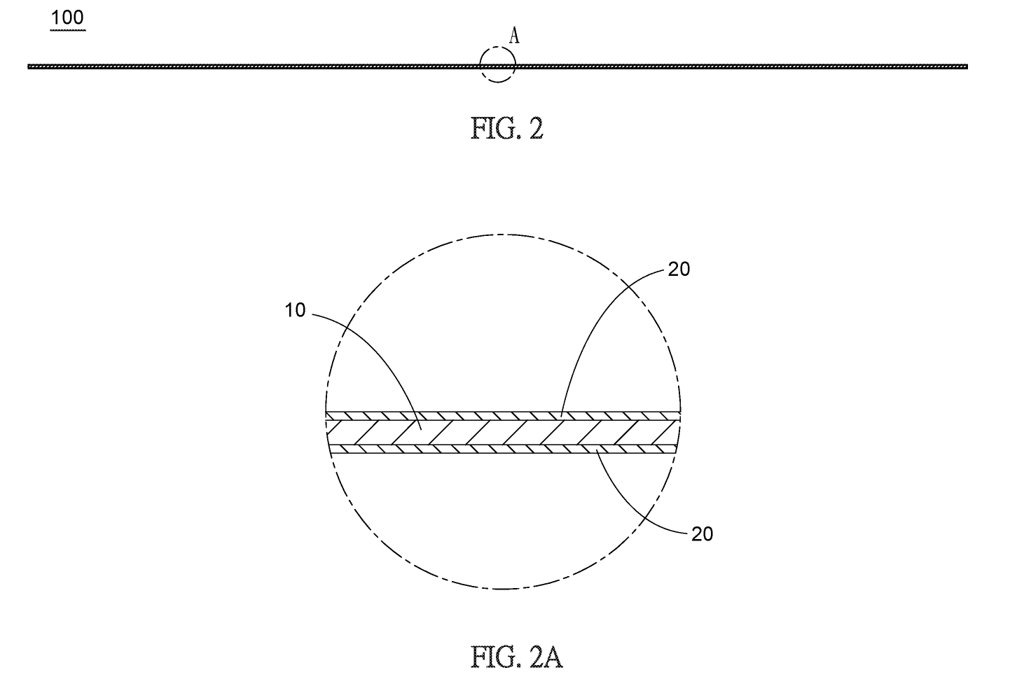

Referring to FIG. 1 to FIG. 3, the present invention discloses an RFID protection and low frequency signal isolation sheet for a folding wallet, having a metal interlayer 10. The upper surface and the lower surface of the metal interlayer 10 are covered with protective layers 20 to form an RFID protection folding sheet 100. The RFID protection folding sheet 100 is inserted into a cash compartment 301 of a folding wallet 30. The length L1 of the RFID protection folding sheet 100 is slightly less than the length L2 of the cash compartment 301. The width W1 of the RFID protection folding sheet 100 is slightly less than the depth D2 of the cash compartment 301.

The metal interlayer 10 is a sheet of aluminum foil or copper foil, which is a shielding material to block (shield) the electromagnetic signal transmission between electronic products. The greater the thickness of the metal interlayer 10, the more significant the shielding effect. The shielding effect of the copper foil is better than that of the aluminum foil.

Preferably, the metal interlayer 10 has a thickness of 0.3-0.7 mm, which is beneficial for the folding wallet 30 to fold the metal interlayer 10 easily.

Moreover, the protective layers 20 are made of a wear-resistant and flexible material to protect the RFID protection folding sheet 100 for durability. The present invention has high economic benefits.

The surface of the protective layer 20 may be printed with at least one pattern or totem 21 as a product identification for promotion.

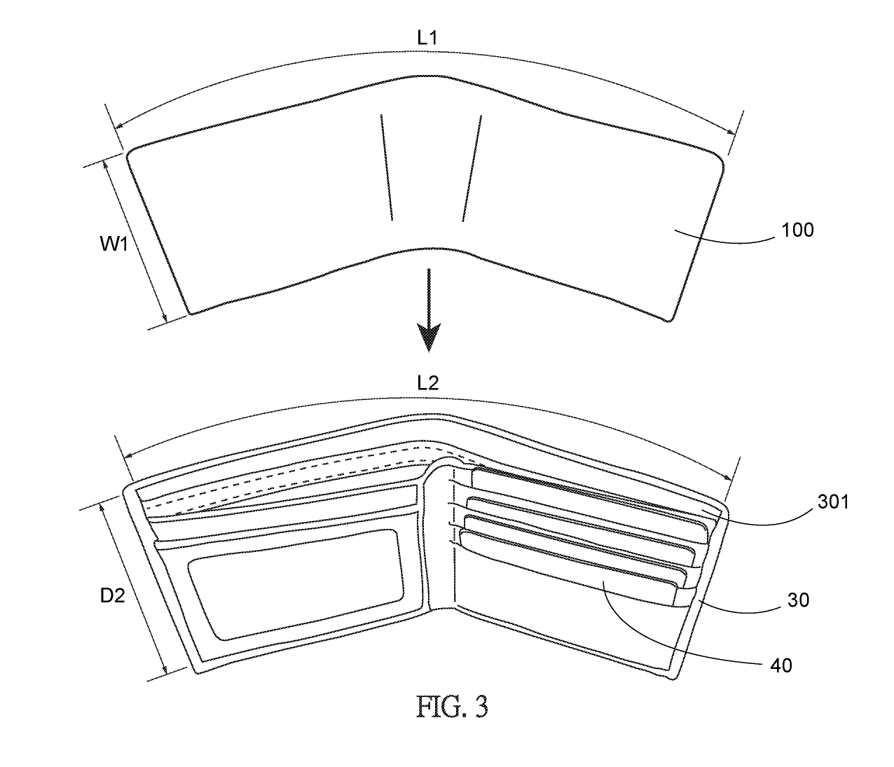

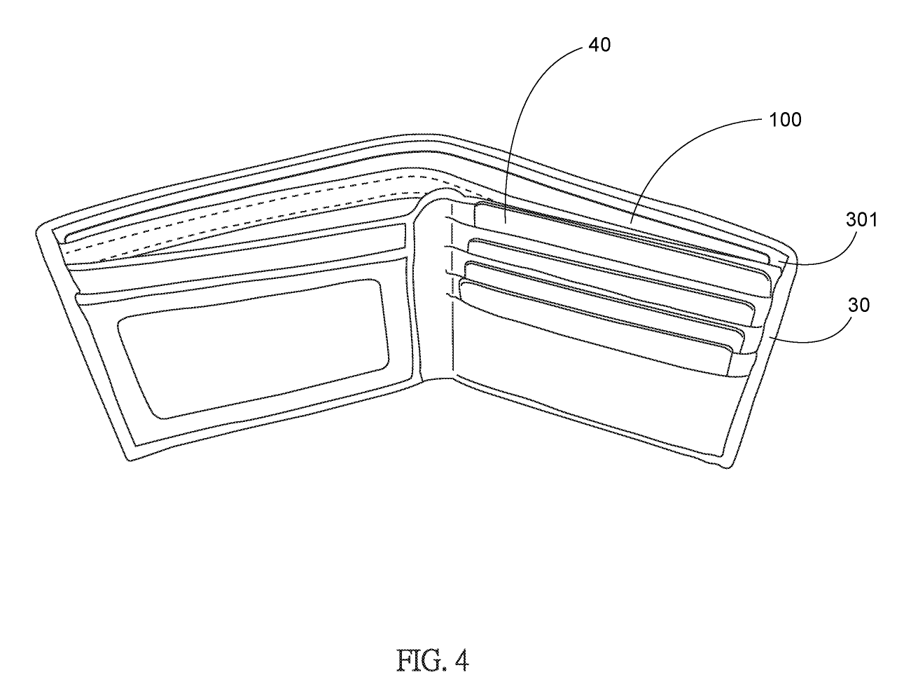

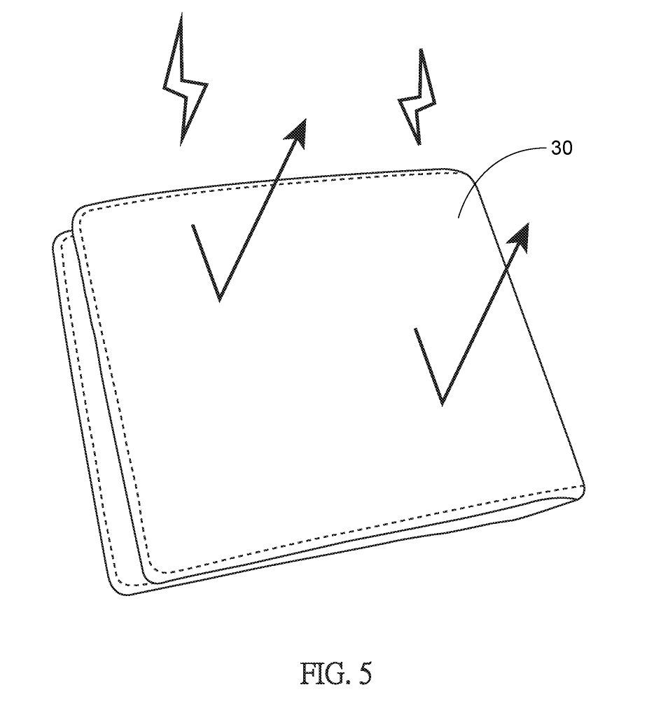

Referring to FIG. 3 to FIG. 5, in detail, the RFID protection folding sheet 100 is first placed into the cash compartment 301 and located at the inner edge close to the outer layer of the folding wallet 30. By folding the folding wallet 30, the RFID protection folding sheet 100 forms the peripheral protection of the folding wallet 30, and the data of the electronic chips (RFID) of a plurality of cards 40 inside the folding wallet 30 is blocked, thereby effectively blocking the transmission and reception of electronic signals or electromagnetic waves inside and outside the folding wallet 30 to achieve RFID protection.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An RFID protection and low frequency signal isolation sheet for a folding wallet, having a metal interlayer, upper and lower surfaces of the metal interlayer being covered with protective layers to form an RFID protection folding sheet, the RFID protection folding sheet being inserted into a cash compartment of a folding wallet, the RFID protection folding sheet having a length slightly less than that of the cash compartment, the RFID protection folding sheet having a width slightly less than a depth of the cash compartment, the RFID protection folding sheet being placed into the cash compartment and located at an inner edge close to an outer layer of the folding wallet.

2. The RFID protection and low frequency signal isolation sheet as claimed in claim 1, wherein the metal interlayer is a sheet of aluminum foil or copper foil.

3. The RFID protection and low frequency signal isolation sheet as claimed in claim 1, wherein the metal interlayer has a thickness of at least 0.3 mm for the folding wallet to fold the metal interlayer easily.

4. The RFID protection and low frequency signal isolation sheet as claimed in claim 1, wherein the protective layers are made of a wear-resistant and flexible material for protecting the RFID protection folding sheet.

5. The RFID protection and low frequency signal isolation sheet as claimed in claim 4, wherein a surface of any one of the protective layers is printed with a pattern or totem as a product identification.
